(19) United States
(12) Patent Application Publication
(10) Pub. No.: US 2013/0306475 A1
(43) Pub. Date: Nov. 21, 2013

(54) GAS SENSOR

(71) Applicant: DENSO CORPORATION, Kariya-city (JP)

(72) Inventors: Yasufumi Suzuki, Kariya-shi (JP); Tooru Katafuchi, Kariya-shi (JP)

(73) Assignee: DENSO CORPORATION, Kariya-city (JP)

(21) Appl. No.: 13/845,571

(22) Filed: Mar. 18, 2013

(30) Foreign Application Priority Data
May 17, 2012 (JP) 2012-113132

(51) Int. Cl. G01N 27/407

(52) U.S. Cl. CPC G01N 27/4077
USPC 204/429; 204/428

(57) ABSTRACT

In a gas sensor, a gas sensor element includes a solid electrolyte body that has a bottomed tubular shape and a pair of reference and measurement electrodes that are respectively provided on the inner and outer surfaces of the solid electrolyte body. A cover is arranged to cover a distal end portion of the gas sensor element. The cover has at least one through-hole that is positioned on a distal side of the distal end portion of the gas sensor element in a longitudinal direction the gas sensor. The measurement electrode is positioned, on the outer surface of the solid electrolyte body, outside of an overlapping area that overlaps with the at least one through-hole of the cover in the longitudinal direction.

### CROSS-REFERENCE TO RELATED APPLICATION

This application is based on and claims priority from Japanese Patent Application No. 2012-113132, filed on May 17, 2012, the content of which is hereby incorporated by reference in its entirety into this application.

### BACKGROUND

1. Technical Field

The present invention relates to gas sensors that sense the concentration of a specific component in a gas to be measured (to be simply referred to as a measurement gas hereinafter).

2. Description of Related Art

There are known gas sensors that are arranged in, for example, the exhaust system of an internal combustion engine of a motor vehicle to detect the concentration of a specific component (e.g., oxygen or nitrogen oxides) in the exhaust gas from the engine (i.e., the measurement gas).

For example, Japanese Unexamined Patent Application Publication No. H1-180447, discloses a gas sensor that includes a gas sensor element for sensing the concentration of a specific component in the exhaust gas and a cover that is arranged to cover a distal end portion of the gas sensor element.

More specifically, the gas sensor element includes a solid electrolyte body and a pair of reference and measurement electrodes. The solid electrolyte body has a bottomed tubular shape so as to define a reference gas chamber therein. The reference electrode is provided on the inner surface of the solid electrolyte body so as to be exposed to a reference gas (e.g., air) that is introduced into the reference gas chamber. On the other hand, the measurement electrode is provided on the outer surface of the solid electrolyte body so as to be exposed to the exhaust gas (i.e., the measurement gas). The cover is arranged to surround a distal end portion of the solid electrolyte body. The cover has a plurality of through-holes formed therein, so that the exhaust gas can be introduced to the measurement electrode via the through-holes.

With the above configuration, the distal end portion of the solid electrolyte body is to be exposed to the exhaust gas. Therefore, during a cold start of the engine, condensate water, which is produced by the condensation of steam included in the exhaust gas, flows to and thereby makes contact with the distal end portion of the solid electrolyte body. Further, the gas sensor element generally includes a heater to heat the solid electrolyte body to a high temperature at which the solid electrolyte body can be activated. Consequently, when the condensate water makes contact with the distal end portion of the highly-heated solid electrolyte body, large thermal shock will be applied to the solid electrolyte body, resulting in cracks in the solid electrolyte body.

To solve the above problem, there has been used a conventional method according to which: a control is performed for suppressing the heating of the solid electrolyte body by the heater during a cold start of the engine, thereby lowering the thermal shock applied to the solid electrolyte body to prevent occurrence of cracks in the solid electrolyte body.

However, in recent years, with market expansion and fuel diversification for internal combustion engines of motor vehicles, various fuel additives and engine oil have been put into use. Those fuel additives and engine oil generally contain poisoning components such as Mn, S, Pb, Si and Ba. Therefore, when the poisoning components are dissolved in the condensate water and the condensate water containing the poisoning components is brought into contact with the distal end portion of the solid electrolyte body of the gas sensor element, the measurement electrode provided on the outer surface of the solid electrolyte body may be poisoned by the poisoning components, resulting in deterioration of the measurement electrode and thus variation in the output of the gas sensor due to the deterioration of the measurement electrode.

That is, though the conventional method is effective in preventing occurrence of cracks in the solid electrolyte body, it has almost no effect in preventing the deterioration of the gas sensor due to the poisoning components.

### SUMMARY

According to an exemplary embodiment, a gas sensor (1) is provided which includes a gas sensor element (2) and a cover (3). The gas sensor element (2) is configured to detect the concentration of a specific component in a measurement gas. The gas sensor element (2) includes a solid electrolyte body (21) and a pair of reference and measurement electrodes (22, 23). The solid electrolyte body (21) has a bottomed tubular shape so as to define a reference gas chamber (20) therein. The reference electrode (22) is provided on the inner surface (211) of the solid electrolyte body (21) so as to be exposed to a reference gas that is introduced into the reference gas chamber (20). The measurement electrode (23) is provided on the outer surface (212) of the solid electrolyte body (21) so as to be exposed to the measurement gas. The cover (3) is arranged to cover a distal end portion (201) of the gas sensor element (2). The cover (3) has at least one through-hole (33) through which the measurement gas is introduced to the measurement electrode (23). The at least one through-hole (33) is positioned on a distal side of the distal end portion (201) of the gas sensor element (2) in a longitudinal direction (X) of the gas sensor (1). The measurement electrode (23) is positioned, on the outer surface (212) of the solid electrolyte body (21), outside of an overlapping area (A) that overlaps with the at least one through-hole (33) of the cover (3) in the longitudinal direction (X) of the gas sensor (1).

With the above configuration, when the gas sensor (1) is arranged in the exhaust system of an internal combustion engine of a motor vehicle to detect the concentration of a specific component in the exhaust gas, it is possible to prevent the measurement electrode (23) from being poisoned by poisoning components contained in the condensate water that is produced by the condensation of steam included in the exhaust gas. Consequently, it is possible to suppress deterioration of the measurement electrode (23), thereby suppressing variation in the output of the gas sensor (1) due to the deterioration of the measurement electrode (23).

It is preferable that a distance (B) between a distal end of the measurement electrode (23) and the at least one through-hole (33) of the cover (3) in the longitudinal direction (X) of the gas sensor (1) is greater than or equal to 7 mm.

It is further preferable that the distance (B) between the distal end of the measurement electrode (23) and the at least one through-hole (33) of the cover (3) in the longitudinal direction (X) of the gas sensor (1) is greater than or equal to 8 mm.

In further implementations, the cover (3) may be substantially cylindrical cup-shaped to include a side wall (31) and a bottom wall (32); the at least one through-hole (33) of the cover (3) may be formed in the bottom wall (32) of the cover (3).

Further, in the above case, the at least one through-hole (33) of the cover (3) may be a single through-hole (33) that is formed at a central portion of the bottom wall (32) of the cover (3).

The gas sensor (1) may further include an outer cover (4) that has a plurality of through-holes (43) formed therein and is arranged to cover the outer periphery of the cover (3).

The gas sensor element (2) may further include a protective layer (24) that is provided to cover at least part of the measurement electrode (23). In this case, it is preferable that the protective layer (24) has a thickness greater than or equal to 200 μm.

It is further preferable that the thickness of the protective layer (24) is greater than or equal to 300 μm.

### BRIEF DESCRIPTION OF THE DRAWINGS

The present invention will be understood more fully from the detailed description given hereinafter and from the accompanying drawings of exemplary embodiments, which, however, should not be taken to limit the invention to the specific embodiments but are for the purpose of explanation and understanding only.

In the accompanying drawings:

FIG. 1 is a schematic cross-sectional view illustrating the overall configuration of a gas sensor according to a first embodiment;

FIG. 2 is an enlarged cross-sectional view of part of the gas sensor around a distal end portion of a gas sensor element of the gas sensor;

FIG. 3 is a cross-sectional view of a side wall of a cover of the gas sensor taken along the line in FIG. 2;

FIG. 4A is a bottom view of the cover of the gas sensor according to the first embodiment;

FIG. 4B is a bottom view of a modification of the cover;

FIG. 5 is a schematic side view of the distal end portion of the gas sensor element;

FIG. 6 is a schematic cross-sectional view of the distal end portion of the gas sensor element;

FIG. 7 is a schematic cross-sectional view illustrating the overall configuration of a gas sensor according to a second embodiment;

FIG. 8 is an enlarged cross-sectional view of part of the gas sensor according to the second embodiment around a distal end portion of a gas sensor element of the gas sensor;

FIG. 9 is a schematic cross-sectional view of a distal end portion of a gas sensor element of a gas sensor according to a third embodiment;

FIG. 10 is an enlarged cross-sectional view of part of a gas senor sample S12 used in. Experiment 1 around a distal end portion of a gas sensor element of the sample S12;

FIG. 11 is a graphical representation showing the results of Experiment 1;

FIG. 12 is a graphical representation showing the results of Experiment 2; and

FIG. 13 is a graphical representation showing the results of Experiment 3.

### DESCRIPTION OF EMBODIMENTS

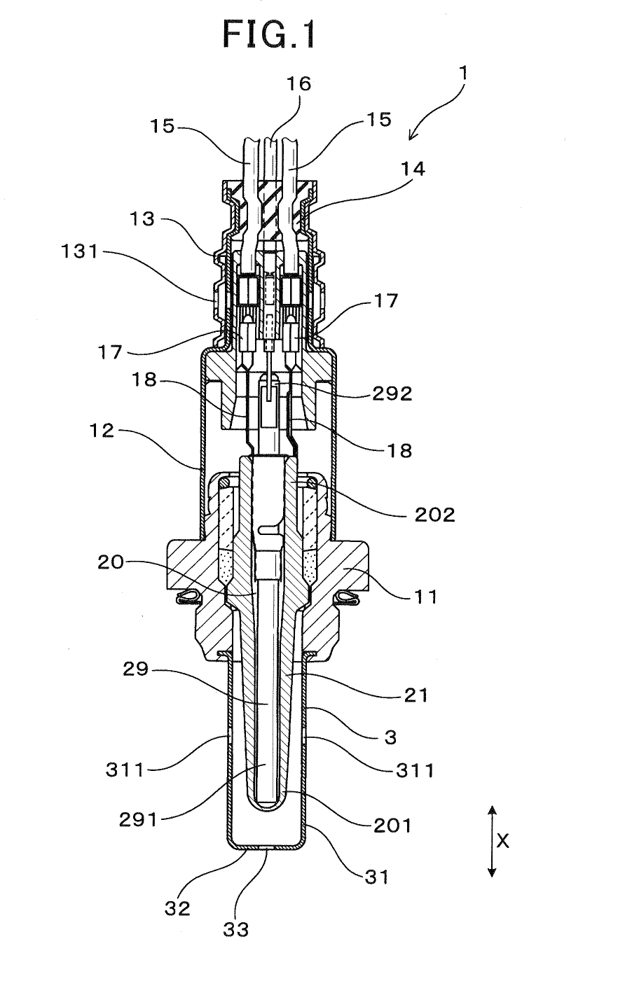

Exemplary embodiments will be described hereinafter with reference to FIGS. 1-13. It should be noted that for the sake of clarity and understanding, identical components having identical functions in different embodiments have been marked, where possible, with the same reference numerals in each of the figures and that for the sake of avoiding redundancy, descriptions of the identical components will not be repeated.

### First Embodiment

As shown in FIGS. 1-6, a gas sensor 1 according to a first embodiment includes a gas sensor element 2 and a cover 3. The gas sensor element 2 is configured to detect the concentration of a specific component in a measurement gas. The gas sensor element 2 includes a solid electrolyte body 21 and a pair of reference and measurement electrodes 22 and 23. The solid electrolyte body 21 has a bottomed tubular shape so as to define a reference gas chamber 20 therein. The reference electrode 22 is provided on the inner surface 211 of the solid electrolyte body 21 so as to be exposed to a reference gas that is introduced into the reference gas chamber 20. The measurement electrode 23 is provided on the outer surface 212 of the solid electrolyte body 21 so as to be exposed to the measurement gas. The cover 3 is arranged to cover a distal end portion 201 of the gas sensor element 2. The cover 3 has at least one through-hole 33 through which the measurement gas is introduced to the measurement electrode 23. The at least one through-hole 33 is positioned on the distal side of the distal end portion 201 of the gas sensor element 2 in a longitudinal direction X of the gas sensor 1. The measurement electrode 23 is positioned, on the outer surface 212 of the solid electrolyte body 21, outside of an overlapping area A that completely overlaps with the at least one through-hole 33 of the cover 3 in the longitudinal direction X of the gas sensor 1.

In addition, it should be noted that: the longitudinal direction X of the gas sensor 1 is represented by the longitudinal (or axial) direction of the solid electrolyte body 21 that has the bottomed tubular shape; the distal side in the longitudinal direction X denotes that side on which the gas sensor 1 is exposed to the measurement gas; and the proximal side denotes the opposite side to the distal side.

The configuration of the gas sensor 1 according to the present embodiment will be described in more detail hereinafter.

In the present embodiment, the gas sensor 1 is designed to be arranged in, for example, the exhaust system of an internal combustion engine of a motor vehicle to detect the concentration of oxygen (i.e., the specific component) in the exhaust gas from the engine (i.e., the measurement gas). In this case, the reference gas may be, for example, air.

As shown in FIG. 1, in the gas sensor 1 according to the present embodiment, the gas sensor element 2 is inserted and held in a tubular housing 11 such that the distal end portion 201 and a proximal end portion 202 of the gas sensor element 2 respectively protrude from the distal and proximal ends of the housing 11.

On the proximal side (i.e., the upper side in FIG. 1) of the housing 11, there is fixed a first proximal-side cover 12 so as to cover the proximal end portion 202 of the gas sensor element 2. Further, on a proximal end portion of the first proximal-side cover 12, there is fixed a second proximal-side cover 13. In the second proximal-side cover 13, there are formed a plurality of through-holes 131 for introducing air (i.e., the reference gas) into the inside of the gas sensor 1. Furthermore, a proximal-side opening portion of the second proximal-side cover 13 is obturated (or blocked) by a sealing member 14. In addition, the sealing member 14 is implemented by, for example, a rubber bush.

In the sealing member 14, there are retained a pair of first lead members 15 and a second lead member 16. The first lead members 15 are respectively connected to a pair of terminals 18 via a pair of connecting members 17. Further, the terminals 18 are respectively in contact with the reference and measurement electrodes 22 and 23, so as to be electrically connected with them. On the other hand, the second lead member 16 is connected to a proximal end portion 292 of a heater 29, so as to supply electric power to the heater 29.

On the distal side (i.e., the lower side in FIG. 1) of the housing 11, there is fixed the cover 3 so as to cover the distal end portion 201 of the gas sensor element 2. In the present embodiment, the cover 3 is substantially cylindrical cup-shaped to include a side wall 31 and a bottom wall 32.

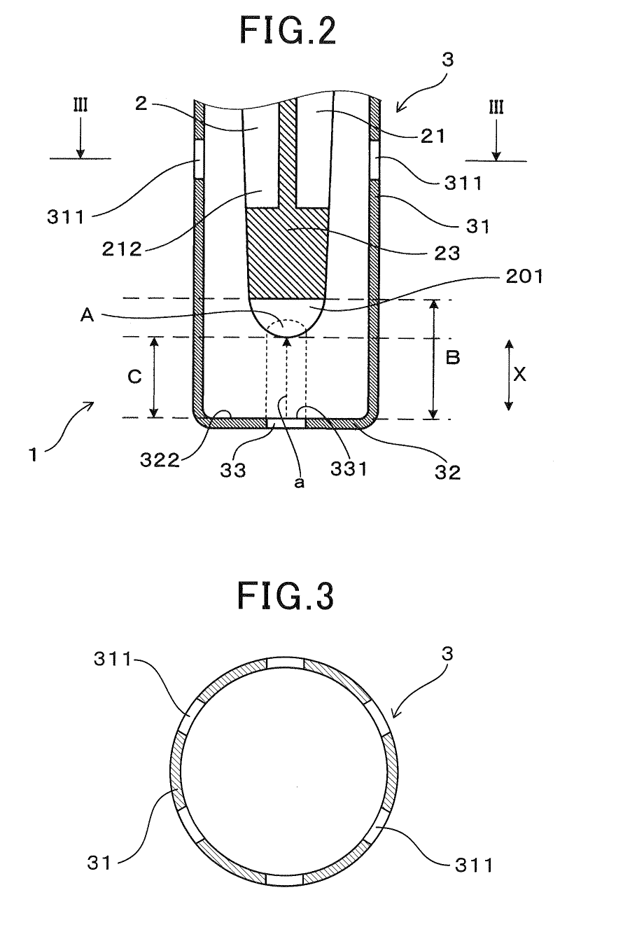

As shown in FIGS. 2 and 3, in the side wall 31 of the cover 3, there are formed a plurality (e.g., six) of through-holes 311 that make up passage holes for the measurement gas. The through-holes 311 are positioned on the proximal side of the distal end of the gas sensor element 2. Further, each of the through-holes 311 is positioned, in the longitudinal direction X of the gas sensor 1, away from an inner surface (or a proximal-side surface) 322 of the bottom wall 32 of the cover 3 by, for example, 10 mm. Moreover, each of the through-holes 311 has a diameter of, for example, 2 mm. In addition, it should be noted that only the side wall 31 of the cover 3 is shown in FIG. 3.

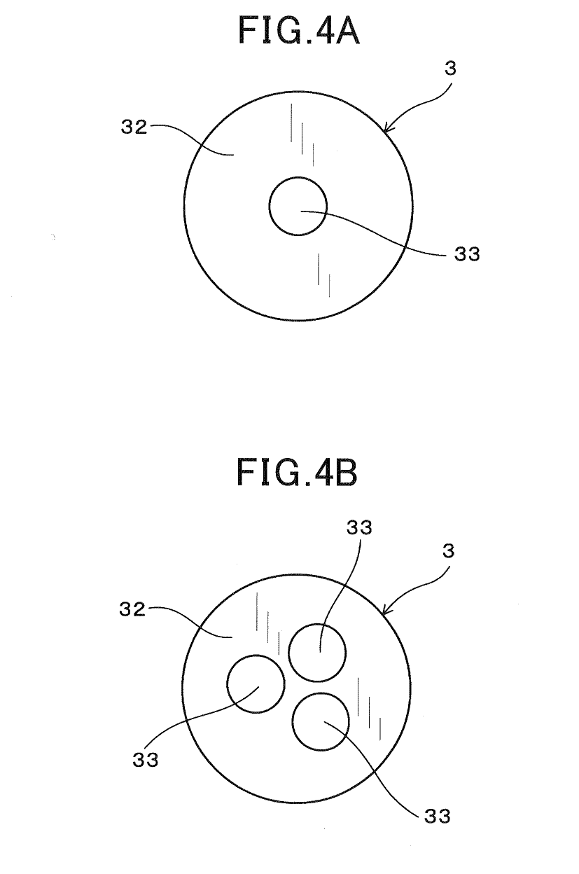

On the other hand, as shown in FIGS. 2 and 4A, in the bottom wall 32 of the cover 3, there is formed the single through-hole 33 through which the measurement gas is introduced to the measurement electrode 23. The through-hole 33 is positioned on the distal side of the distal end portion 201 of the gas sensor element 2; the distal end portion 201 includes the distal end of the gas sensor element 2. Further, the through-hole 33 is formed at a central portion of the bottom wall 32 of the cover 3. Moreover, the through-hole 33 has a diameter of, for example, 2.5 mm, while the bottom wall 32 of the cover 3 has a diameter of, for example, 9 mm.

In addition, though there is formed in the bottom wall 32 of the cover 3 only the single through-hole 33 in the present embodiment, it is also possible to form a plurality (e.g., 3) of through-holes 33 in the bottom wall 32 as shown in FIG. 4B. Further, though not graphically shown, it is also possible to form one or more through-holes 33 in the side wall 31 of the cover 3 so as to be positioned on the distal side of the distal end portion 201 of the gas sensor element 2.

As shown in FIGS. 1 and 5-6, in the present embodiment, the solid electrolyte body 21 of the gas sensor element 2 has a substantially bottomed cylindrical shape with its distal end closed and its proximal end open. The solid electrolyte body 21 has oxygen ion conductivity, and has the reference gas chamber 20 formed therein. The solid electrolyte body 21 is made of a ceramic material whose major component is, for example, zirconia (ZrO₂).

In the reference gas chamber 20 of the solid electrolyte body 21, there is disposed the heater 29 so that a distal end portion 291 of the heater 29 is in contact with the inner surface 211 of the solid electrolyte body 21. In the present embodiment, the heater 29 is substantially rod-shaped and made, for example, of a ceramic material.

On the inner surface 211 of the solid electrolyte body 21, there is formed the reference electrode 22 so as to be exposed to the reference gas (i.e., air in the present embodiment) that is introduced into the reference gas chamber 20. On the other hand, on the outer surface 212 of the solid electrolyte body 21, there is formed the measurement electrode 23 so as to be exposed to the measurement gas (i.e., the exhaust gas) that is introduced into the hollow space formed in the cover 3.

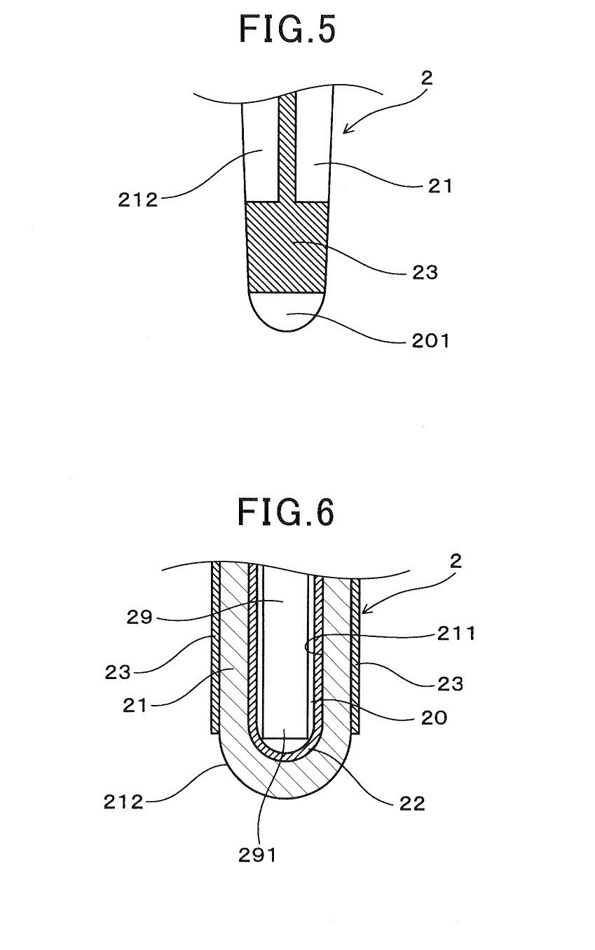

Further, as shown in FIGS. 2 and 5, in the present embodiment, the measurement electrode 23 is formed on the outer surface 212 of the solid electrolyte body 21 so as to fall outside of the range of 0 to 1 mm for distance in the longitudinal direction X of the gas sensor 1 from the distal end of the solid electrolyte body 21. However, in the range of 1 to 10 mm for distance in the longitudinal direction X from the distal end of the solid electrolyte body 21, the measurement electrode 23 is formed over the entire circumference of the solid electrolyte body 21.

Furthermore, in the present embodiment, the measurement electrode 23 is positioned on the outer surface 212 of the solid electrolyte body 21 so as to fall outside of the overlapping area A of the outer surface 212; the overlapping area A completely overlaps with the through-hole 33 of the cover 3 in the longitudinal direction X of the gas sensor 1.

In addition, in the present embodiment, the longitudinal direction X of the gas sensor 1 coincides with the direction a (see FIG. 2) along which the distance from the center of a proximal-side opening 331 of the through-hole 33 to the solid electrolyte body 21 is shortest.

Moreover, in the present embodiment, the distance B between the distal end of the measurement electrode 23 and the through-hole 33 of the cover 3 in the longitudinal direction X of the gas sensor 1 is greater than or equal to 7 mm.

In addition, in the case of forming a plurality of through-holes 33 in the cover 3, the distance B represents the distance in the longitudinal direction X between the distal end of the measurement electrode 23 and that one of the through-holes 33 which is closest to the distal end of the solid electrolyte body 21 in the longitudinal direction X.

After having described the configuration of the gas sensor 1 according to the present embodiment, advantages thereof will be described hereinafter.

In the gas sensor 1, the cover 3 has the through-hole 33 through which the measurement gas (i.e., the exhaust gas) is introduced to the measurement electrode 23. The through-hole 33 of the cover 3 is positioned on the distal side of the distal end portion 201 of the gas sensor element 2 in the longitudinal direction X of the gas sensor 1. The measurement electrode 23 is formed, on the outer surface 212 of the solid electrolyte body 21, outside of the overlapping area A that completely overlaps with the through-hole 33 of the cover 3 in the longitudinal direction X of the gas sensor 1.

With the above configuration, it is possible to prevent the measurement electrode 23 from being poisoned by poisoning components contained in the condensate water that is produced by the condensation of steam included in the exhaust gas. Consequently, it is possible to suppress deterioration of the measurement electrode 23, thereby suppressing variation in the output of the gas sensor 1 due to the deterioration of the measurement electrode 23.

More specifically, the inventors of the present invention have found that the relative position between the through-hole 33 of the cover 3 and the measurement electrode 23 is very important to protection of the measurement electrode 23 from the poisoning components contained in the condensate water. This is because the condensate water flows, along with the exhaust gas, into the hollow space formed in the cover 3 via the through-hole 33.

The inventors have also found that by positioning the measurement electrode 23 outside of the overlapping area A, it is possible to: (1) prevent the condensate water, which has just flowed into the hollow space formed in the cover 3 along with the exhaust gas, from further flowing to and thereby making contact with the measurement electrode 23; and (2) prevent the condensate water, which has previously entered and stagnated in the hollow space formed in the cover 3, from making contact with the measurement electrode 3 with the help of flow of the exhaust gas. Consequently, it is possible to prevent the measurement electrode 23 from being poisoned by the poisoning components contained in the condensate water. In other words, it is possible to secure high durability of the measurement electrode 23 against the poisoning components contained in the condensate water. As a result, it is possible to suppress deterioration of the measurement electrode 23, thereby suppressing variation in the output of the gas sensor 1 due to the deterioration of the measurement electrode 23 and securing excellent responsiveness of the gas sensor 1.

In the gas sensor 1, the distance B between the distal end of the measurement electrode 23 and the through-hole 33 of the cover 3 in the longitudinal direction X of the gas sensor 1 is set to be greater than or equal to 7 mm.

Setting the distance B as above, it is possible to more reliably prevent the measurement electrode 23 from being poisoned by the poisoning components included in the condensate water, thereby improving the advantageous effects of suppressing deterioration of the measurement electrode 23 and thus variation in the output of the gas sensor 1.

Moreover, to further improve the above advantageous effects, it is preferable to set the distance B greater than or equal to 8 mm.

In the present embodiment, the cover 3 is substantially cylindrical cup-shaped to include the side wall 31 and the bottom wall 32. The through-hole 33 is formed in the bottom wall 32 of the cover 3.

With the substantially cylindrical cup shape, it is possible for the cover 3 to completely cover the distal end portion 201 of the gas sensor element 2 which protrudes from the distal end of the housing 11.

Further, in the present embodiment, there is only the single through-hole 33 formed at the central portion of the bottom wall 32 of the cover 3.

With the above formation, it is possible to easily provide the through-hole 33 in the cover 3. In addition, it is also possible to maximize the distance from the through-hole 33 to the measurement electrode 23.

### Second Embodiment

This embodiment illustrates a gas sensor 1 which has a similar configuration to the gas sensor 1 according to the first embodiment; accordingly, only the differences therebetween will be described hereinafter.

In the first embodiment, the gas sensor 1 includes only the single cover 3 on the distal side of the housing 11 (see FIG. 1).

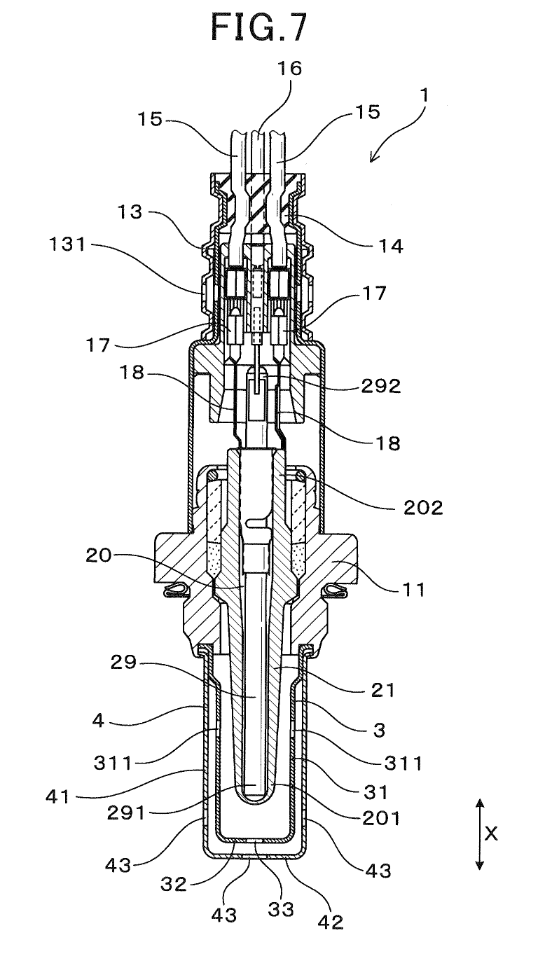

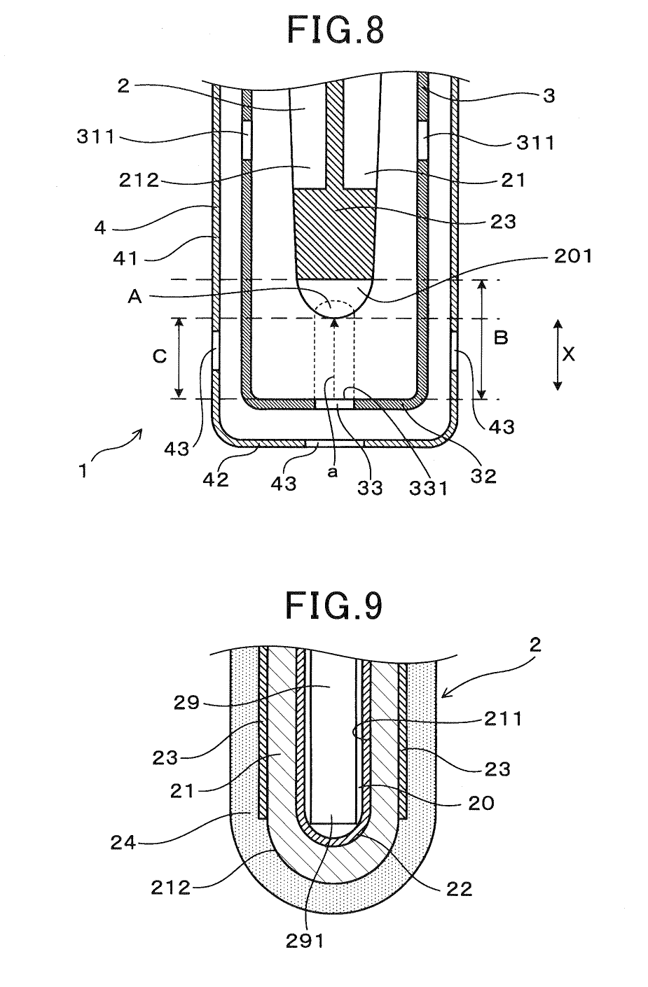

In comparison, in the present embodiment, as shown in FIGS. 7 and 8, the gas sensor 1 further includes, in addition to the cover 3, an outer cover 4 on the distal side of the housing 11.

The outer cover 4 is also substantially cylindrical cup-shaped to include a side wall 41 and a bottom wall 42. The outer cover 4 is fixed, together with the cover 3, to the distal end of the housing 11 so as to cover the outer periphery of the cover 3.

Moreover, in the side wall 41 of the outer cover 4, there are formed a plurality of through-holes 43 that make up passage holes for the measurement gas. On the other hand, in the bottom wall 42 of the outer cover 4, there is formed one through-hole 43 that also makes up a passage hole for the measurement gas.

The through-hole 43 formed in the bottom wall 42 of the outer cover 4 is aligned with the through-hole 33 formed in the bottom wall 32 of the cover 3 in the longitudinal direction X of the gas sensor 1. Further, the through-hole 43 formed in the bottom wall 42 of the outer cover 4 has a larger diameter than the through-hole 33 formed in the bottom wall 32 of the cover 3.

In addition, it is also possible to form a plurality of through-holes 43 in the bottom wall 42 of the outer cover 4 when the cover 3 is modified to have a plurality of through-holes 33 formed in the bottom wall 32.

The above gas sensor 1 according to the present embodiment has the same advantages as the gas sensor 1 according to the first embodiment. In other words, with the outer cover 4 additionally provided to cover the outer periphery of the cover 3, it is still possible to achieve the same advantageous effects as described in the first embodiment.

### Third Embodiment

This embodiment illustrates a gas sensor 1 which has a similar configuration to the gas sensor 1 according to the first embodiment; accordingly, only the differences therebetween will be described hereinafter.

In the first embodiment, the gas sensor 1 has no protective layer covering the distal end portion 201 of the gas sensor element 2. Consequently, the measurement electrode 23 and the solid electrolyte body 21 of the gas sensor element 2 are directly exposed to the measurement gas introduced into the hollow space formed in the cover 3 (see FIG. 2).

In comparison, as shown in FIG. 9, in the present embodiment, the gas sensor 1 further includes a protective layer 24 that covers the distal end portion 201 of the gas sensor element 2. Consequently, the measurement electrode 23 and the solid electrolyte body 21 of the gas sensor element 2 are not directly exposed to the measurement gas introduced into the hollow space formed in the cover 3.

The protective layer 24 is made of a porous ceramic material which mainly contains alumina (Al₂O₃), magnesia (MgO) and titania (TiO₂). The protective layer 24 is provided to trap gaseous poisoning components included in the measurement gas (i.e., the exhaust gas).

In the present embodiment, the thickness of the protective layer 24 is set to be greater than or equal to 200 μm.

Setting the thickness of the protective layer 24 as above, it is possible to more reliably prevent the measurement electrode 23 from being poisoned by the poisoning components included in the condensate water, thereby improving the advantageous effects of suppressing deterioration of the measurement electrode 23 and thus variation in the output of the gas sensor 1.

Moreover, to further improve the above advantageous effects, it is preferable to set the thickness of the protective layer 24 greater than or equal to 300 μm.

In addition, though the protective layer 24 is formed to cover the entire distal end portion 201 of the gas sensor element 2 in the present embodiment, it is also possible to form the protective layer 24 to cover only part of the measurement electrode 23 included in the distal end portion 201 of the gas sensor element 2.

Moreover, the protective layer 24 may be formed by laminating a plurality of layers; those layers include, for example, a gas stabilization layer that is formed by plasma spraying, a trap layer for trapping gaseous poisoning components included in the measurement gas, and a catalyst layer that contains catalytic noble metals, such as Pt, Pd and Rh, so as to burn hydrogen contained in the measurement gas by catalysis of the catalytic noble metals. In this case, the thickness of the protective layer 24 is represented by the sum of thicknesses of all the layers that are laminated together to form the protective layer 24.

### [Experiment 1]

This experiment has been conducted to determine the effects of design parameters on deterioration of the measurement electrode 23 of the gas sensor element 2.

In the experiment, gas sensor samples S11 and S12 were prepared, all of which had the same basic configuration as the gas sensor 1 according to the second embodiment (see FIGS. 7 and 8).

TABLE 1

| | ELECTRODE | | COVER 3 | | | | |
|---|---|---|---|---|---|---|---|
| | FALLING IN | | | | THROUGH-HOLES 311 | | |
| GAS | OR OUT OF | | THROUGH-HOLE 33 | | DISTANCE FROM | | |
| SENSOR | OVERLAPPING | NUMBER OF | | DIAMETER | BOTTOM WALL | | DIAMETER |
| SAMPLES | AREA | COVERS | NUMBER | (mm) | (mm) | NUMBER | (mm) |
| S11 | OUT | 2 | 1 | 2.5 | 10 | 6 | 2 |
| S12 | IN | 2 | 1 | 2.5 | 10 | 6 | 2 |

Specifically, as shown in TABLE 1, all the gas sensor samples S11 and S12 had both the cover 3 and the outer cover 4. That is, in each of the gas sensor samples S11 and S12, the number of the distal-side covers is equal to 2. Moreover, in each of the gas sensor samples S11 and S12, the number of the through-holes 33 formed in the bottom wall 32 of the cover 3 was equal to 1; the diameter of the through-hole 33 was equal to 2.5 mm; the number of the through-holes 311 formed in the side wall 31 of the cover 3 was equal to 6; the diameter of the through-holes 311 was equal to 2 mm; the distance from the inner surface 322 of the bottom wall 32 of the cover 3 to the through-holes 311 in the longitudinal direction X of the gas sensor sample was equal to 10 mm.

In each of the gas sensor samples S11, as shown in FIG. 8, the measurement electrode 23 was formed on the outer surface 212 of the solid electrolyte body 21 so as to fall outside of the overlapping area A. Further, the measurement electrode 23 was formed so as to fall outside of the range of 0 to 1 mm for distance in the longitudinal direction X from the distal end of the solid electrolyte body 21. However, in the range of 1 to 10 mm for distance in the longitudinal direction X from the distal end of the solid electrolyte body 21, the measurement electrode 23 was formed over the entire circumference of the solid electrolyte body 21.

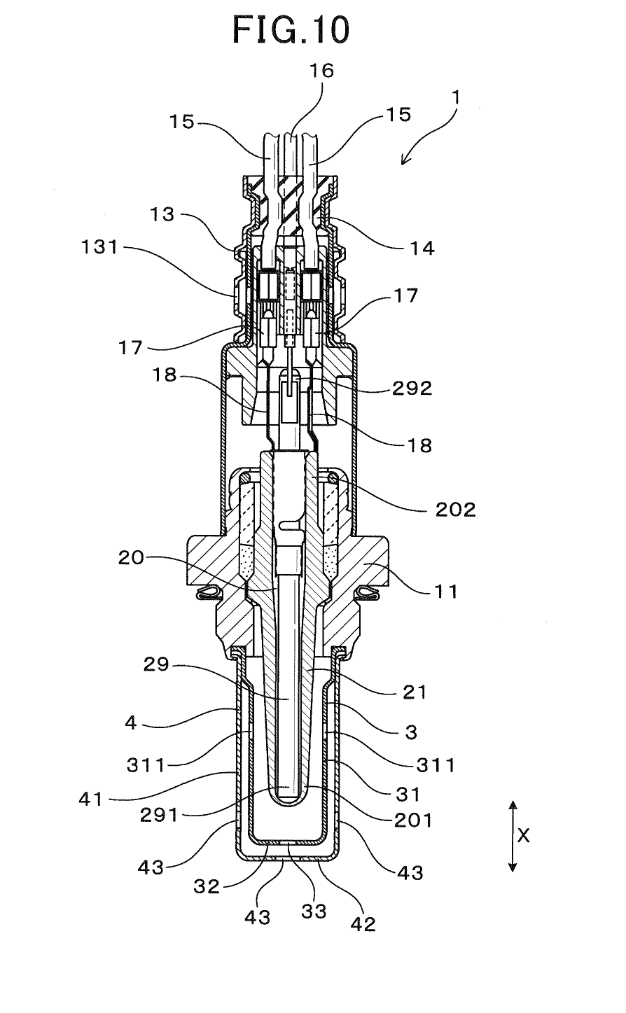

In comparison, in each of the gas sensor samples S12, as shown in FIG. 10, the measurement electrode 23 was formed on the outer surface 212 of the solid electrolyte body 21 so as to fall in the overlapping area A. Further, in the range of 0 to 10 mm for distance in the longitudinal direction X from the distal end of the solid electrolyte body 21, the measurement electrode 23 was formed over the entire circumference of the solid electrolyte body 21.

Furthermore, for the gas sensor samples S11, the distance B between the distal end of the measurement electrode 23 and the through-hole 33 of the cover 3 in the longitudinal direction X was varied in the range of 1.5 to 10 mm by varying the distance C (see FIG. 8) between the inner surface 322 of the bottom wall 32 of the cover 3 and the distal end of the solid electrolyte body 21 in the range of 0.5 to 9 mm. On the other hand, for the gas sensor samples S12, the distance B between the distal end of the measurement electrode 23 and the through-hole 33 of the cover 3 in the longitudinal direction X was varied in the range of 1.5 to 10 mm by varying the distance C (see FIG. 10) between the inner surface 322 of the bottom wall 32 of the cover 3 and the distal end of the solid electrolyte body 21 in the range of 1.5 to 10 mm.

Each of the above gas sensor samples S11 and S12 was cyclically tested until the measurement electrode 23 of the gas senor sample was determined as being deteriorated.

Specifically, in each cycle of the test, the gas sensor sample was first mounted to a simulated exhaust pipe that simulates the exhaust pipe of an internal combustion engine.

Secondly, air is made to flow through the simulated exhaust pipe at a speed of 20 m/s.

Thirdly, an aqueous solution containing 10 wt % Mn was injected into the simulated exhaust pipe at a position upstream from the gas sensor sample by 50 mm.

Fourthly, the heater 29 of the gas sensor sample was supplied with electric power to generate heat, thereby heating the gas sensor element 2 of the gas sensor sample and keeping the temperature of the distal end portion 201 of the gas sensor element 2 at 550° C. for 3 minutes.

Fifthly, the electric power supply to the heater 29 of the gas sensor sample was stopped, and the gas sensor sample was removed from the simulated exhaust pipe.

Next, the gas sensor sample was mounted to a gas generator, thereby being exposed to a test gas generated by the gas generator; the flow rate of the test gas was 3 L/min. Then, the A/F (Air/Fuel) ratio of the test gas was changed from rich (A/F ratio=14, the output of the gas sensor sample>0.8V) to lean (A/F ratio=15, the output of the gas sensor sample<0.2V). If the output of the gas sensor sample was still higher than 0.2V after 20 s from the changing of the A/F ratio of the test gas from rich to lean, then the measurement electrode 23 of the gas senor sample was determined as being deteriorated.

In addition, the gas sensor sample was exposed to the test gas with the temperature of the distal end portion 201 of the gas sensor element 2 of the gas sensor sample kept at 550° C. The test gas was a mixture of CO gas, O₂ gas and N₂ gas. The air/fuel ration of the test was changed by changing the mixing ratio between the O₂ gas and N₂ gas.

All the above steps were repeated until the measurement electrode 23 of the gas senor sample was determined as being deteriorated. Then, the number of cycles required for deteriorating the measurement electrode 23 of the gas sensor sample was recorded, which represents the durability of the gas sensor sample.

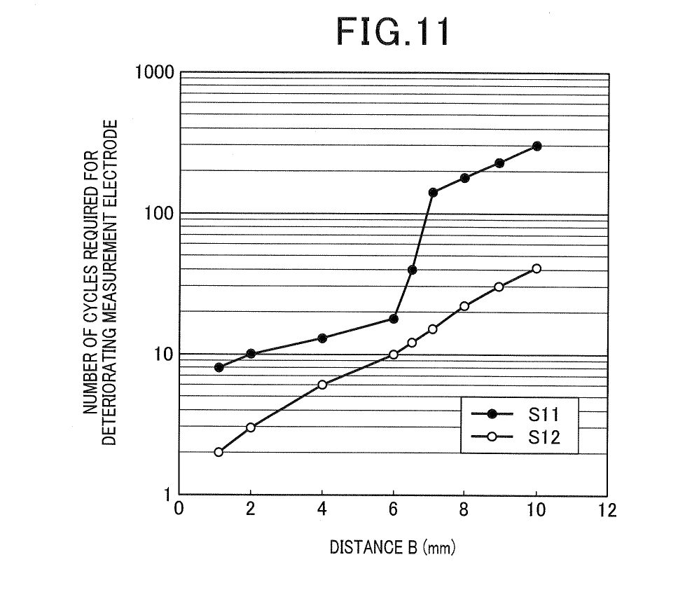

FIG. 11 shows the test results, wherein: the horizontal axis represents the distance B between the distal end of the measurement electrode 23 and the through-hole 33 of the cover 3 in the longitudinal direction X; the vertical axis represents the number of cycles required for deteriorating the measurement electrode 23; the plots “” indicate the results with the gas sensor samples S11; and the plots “∘” indicate the results with the gas sensor samples S12.

It can be seen from FIG. 11 that in the entire range of the distance B, the gas sensor samples S11 were superior to the gas sensor samples S12 in terms of the number of cycles required for deteriorating the measurement electrode 23 (i.e., in terms of durability).

Accordingly, from the above test results, it has been made clear that deterioration of the measurement electrode 23 can be suppressed by forming the measurement electrode 23 on the outer surface 212 of the solid electrolyte body 21 so as to fall outside of the overlapping area A.

### [Experiment 2]

This experiment has been conducted to determine the effect of the distance B on deterioration of the measurement electrode 23 of the gas sensor element 2.

In the experiment, gas sensor samples S21-S25 were prepared, among which: the gas sensor samples S21 had the same basic configuration as the gas sensor 1 according to the first embodiment (see FIGS. 1 and 2); and the gas sensor samples S22-S25 had the same basic configuration as the gas sensor 1 according to the second embodiment (see FIGS. 7 and 8).

TABLE 2

| | ELECTRODE | | COVER 3 | | | | |
|---|---|---|---|---|---|---|---|
| | FALLING IN | | | | THROUGH-HOLES 311 | | |
| GAS | OR OUT OF | | THROUGH-HOLE 33 | | DISTANCE FROM | | |
| SENSOR | OVERLAPPING | NUMBER OF | | DIAMETER | BOTTOM WALL | | DIAMETER |
| SAMPLES | AREA | COVERS | NUMBER | (mm) | (mm) | NUMBER | (mm) |
| S21 | OUT | 1 | 1 | 2.5 | 10 | 6 | 2 |
| S22 | OUT | 2 | 1 | 2.5 | 10 | 6 | 2 |
| S23 | OUT | 2 | 3 | 2.5 | 10 | 6 | 2 |
| S24 | OUT | 2 | 1 | 2.5 | 10 | 6 | 2 |
| S25 | IN | 2 | 1 | 2.5 | 10 | 6 | 2 |

Specifically, as shown in TABLE 2, the gas sensor samples S21 had only one distal-side cover, i.e., the cover 3; in other words, the number of the distal-side covers in each of the gas sensor samples S21 was equal to 1. All the other gas sensor samples S22-S24 had both the cover 3 and the outer cover 4; in other words, the number of the distal-side covers in each of the samples S22-S24 was equal to 2.

Moreover, in each of the gas sensor samples S21-S24, the measurement electrode 23 was formed on the outer surface 212 of the solid electrolyte body 21 so as to fall outside of the overlapping area A (see FIGS. 2 and 8). On the other hand, in each of the gas sensor samples S25, the measurement electrode 23 was formed on the outer surface 212 of the solid electrolyte body 21 so as to fall in the overlapping area A (see FIG. 10).

In each of the gas sensor samples S21-S22 and S24-S25, there was only the single through-hole 33 formed in the bottom wall 32 of the cover 3 (see FIG. 4A). On the other hand, in each of the gas sensor samples S23, there were three through-holes 33 formed in the bottom wall 32 of the cover 3 (see FIG. 4B).

In each of the gas sensor samples S21-S25, the diameter of the through-hole(s) 33 was equal to 2.5 mm. The number of the through-holes 311 formed in the side wall 31 of the cover 3 was equal to 6. The diameter of the through-holes 311 was equal to 2 mm. The distance from the inner surface 322 of the bottom wall 32 of the cover 3 to the through-holes 311 in the longitudinal direction X of the gas sensor sample was equal to 10 mm.

In each of the gas sensor samples S21-S23, the measurement electrode 23 was formed so as to fall outside of the range of 0 to 1 mm for distance in the longitudinal direction X from the distal end of the solid electrolyte body 21. However, in the range of 1 to 10 mm for distance in the longitudinal direction X from the distal end of the solid electrolyte body 21, the measurement electrode 23 was formed over the entire circumference of the solid electrolyte body 21 (see FIGS. 2 and 8).

Moreover, for the gas sensor samples S21-S23, the distance B between the distal end of the measurement electrode 23 and the through-hole(s) 33 of the cover 3 in the longitudinal direction X was varied in the range of 1.5 to 10 mm by varying the distance C (see FIGS. 2 and 8) between the inner surface 322 of the bottom wall 32 of the cover 3 and the distal end of the solid electrolyte body 21 in the range of 0.5 to 9 mm.

In each of the gas sensor samples S24, the measurement electrode 23 was formed so as to fall outside of the range of 0 to a predetermined value for distance in the longitudinal direction X from the distal end of the solid electrolyte body 21; the predetermined value was selected from the range of 0.5 to 0.8 mm. However, in the range from the predetermined value to 10 mm for distance in the longitudinal direction X from the distal end of the solid electrolyte body 21, the measurement electrode 23 was formed over the entire circumference of the solid electrolyte body 21 (see FIG. 8).

Moreover, for the gas sensor samples S24, the distance B between the distal end of the measurement electrode 23 and the through-hole 33 of the cover 3 in the longitudinal direction X was varied in the range of 2 to 10 mm by varying the position of the distal end of the measurement electrode 23 in the longitudinal direction X with the distance C fixed at 1.5 mm (see FIG. 8).

As described previously, in each of the gas sensor samples S25, the measurement electrode 23 was formed on the outer surface 212 of the solid electrolyte body 21 so as to fall in the overlapping area A (see FIG. 10). Further, in the range of 0 to 10 mm for distance in the longitudinal direction X from the distal end of the solid electrolyte body 21, the measurement electrode 23 was formed over the entire circumference of the solid electrolyte body 21

Moreover, for the gas sensor samples S25, the distance B between the distal end of the measurement electrode 23 and the through-hole 33 of the cover 3 in the longitudinal direction X was varied in the range of 1.5 to 10 mm by varying the distance C (see FIG. 10) between the inner surface 322 of the bottom wall 32 of the cover 3 and the distal end of the solid electrolyte body 21 in the range of 1.5 to 10 mm.

Each of the above gas sensor samples S21-S25 was cyclically tested, in the same way as in Experiment 1, until the measurement electrode 23 of the gas senor sample was determined as being deteriorated.

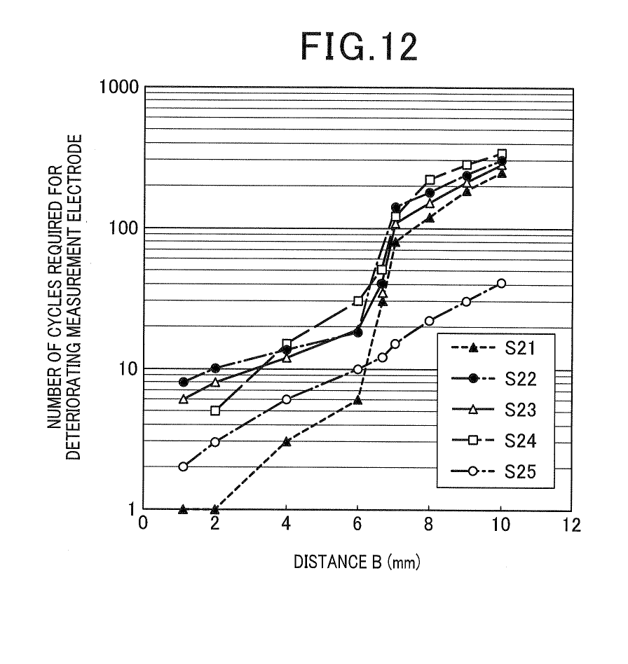

FIG. 12 shows the test results, wherein: the horizontal axis represents the distance B between the distal end of the measurement electrode 23 and the through-hole(s) 33 of the cover 3 in the longitudinal direction X; the vertical axis represents the number of cycles required for deteriorating the measurement electrode 23; the plots “▴” indicate the results with the gas sensor samples S21; the plots “” indicate the results with the gas sensor samples S22; the plots “Δ” indicate the results with the gas sensor samples S23; the plots “□” indicate the results with the gas sensor samples S24; and the plots “∘” indicate the results with the gas sensor samples S25.

As seen from FIG. 12, when the distance B was greater than or equal to 7 mm, the number of cycles required for deteriorating the measurement electrode 23 for the gas sensor samples S21-S24 was considerably larger than that for the gas sensor samples S25. Further, when the distance B was greater than or equal to 8 mm, the number of cycles required for deteriorating the measurement electrode 23 for the gas sensor samples S21-S24 was remarkably larger than that for the gas sensor samples S25.

Accordingly, from the above test results, it has been made clear that to more reliably suppress deterioration of the measurement electrode 23, the distance B is preferably set to be greater than or equal to 7 mm, and more preferably set to be greater than or equal to 8 mm.

### [Experiment 3]

This experiment has been conducted to determine the effect of the thickness of the protective layer 24 on deterioration of the measurement electrode 23 of the gas sensor element 2 in the gas sensor 1 according to the third embodiment.

In the experiment, gas sensor samples S31-S34 were prepared, all of which had the same basic configuration as the gas sensor 1 according to the third embodiment (see FIG. 9).

Specifically, as shown in TABLE 3, in each of the gas sensor samples S31-S34, the measurement electrode 23 was formed on the outer surface 212 of the solid electrolyte body 21 so as to fall outside of the overlapping area A (see FIG. 8); the number of the distal-side covers was equal to 2 (see FIG. 8); there was only the single through-hole 33 formed in the bottom wall 32 of the cover 3 (see FIG. 4A); the diameter of the through-hole 33 was equal to 2.5 mm; the number of the through-holes 311 formed in the side wall 31 of the cover 3 was equal to 6; the diameter of the through-holes 311 was equal to 2 mm; the distance from the inner surface 322 of the bottom wall 32 of the cover 3 to the through-holes 311 in the longitudinal direction X of the gas sensor sample was equal to 10 mm.

TABLE 3

| | | | COVER 3 | | | | | |
|---|---|---|---|---|---|---|---|---|
| | | | | | THROUGH-HOLES 311 | | | |
| | ELECTRODE | | | | DISTANCE | | | |
| GAS | FALLING IN | | | | FROM | | | PROTECTIVE |
| PROTECTIVE | OR OUT OF | NUMBER | THROUGH-HOLE 33 | | BOTTOM | | | LAYER |
| SENSOR | OVERLAPPING | OF | | DIAMETER | WALL | | DIAMETER | THICKNESS |
| SAMPLES | AREA | COVERS | NUMBER | (mm) | (mm) | NUMBER | (mm) | (μm) |
| S31 | OUT | 2 | 1 | 2.5 | 10 | 6 | 2 | 50 |
| S32 | OUT | 2 | 1 | 2.5 | 10 | 6 | 2 | 100 |
| S33 | OUT | 2 | 1 | 2.5 | 10 | 6 | 2 | 200 |
| S34 | OUT | 2 | 1 | 2.5 | 10 | 6 | 2 | 300 |

Moreover, in each of the gas sensor samples S31-S34, the measurement electrode 23 was formed so as to fall outside of the range of 0 to 1 mm for distance in the longitudinal direction X from the distal end of the solid electrolyte body 21. However, in the range of 1 to 10 mm for distance in the longitudinal direction X from the distal end of the solid electrolyte body 21, the measurement electrode 23 was formed over the entire circumference of the solid electrolyte body 21 (see FIG. 8).

The thickness of the protective layer 24 was equal to 50 μm in the gas senor samples S31, 100 μm in the gas senor samples S32, 200 μm in the gas senor samples S33, and 300 μm in the gas senor samples S34.

In addition, for the gas sensor samples S31-S34, the distance B between the distal end of the measurement electrode 23 and the through-hole 33 of the cover 3 in the longitudinal direction X was varied in the range of 1.5 to 10 mm by varying the distance C (see FIG. 8) between the inner surface 322 of the bottom wall 32 of the cover 3 and the distal end of the solid electrolyte body 21 in the range of 0.5 to 9 mm.

Each of the above gas sensor samples S31-S34 was cyclically tested, in the same way as in Experiment 1, until the measurement electrode 23 of the gas senor sample was determined as being deteriorated.

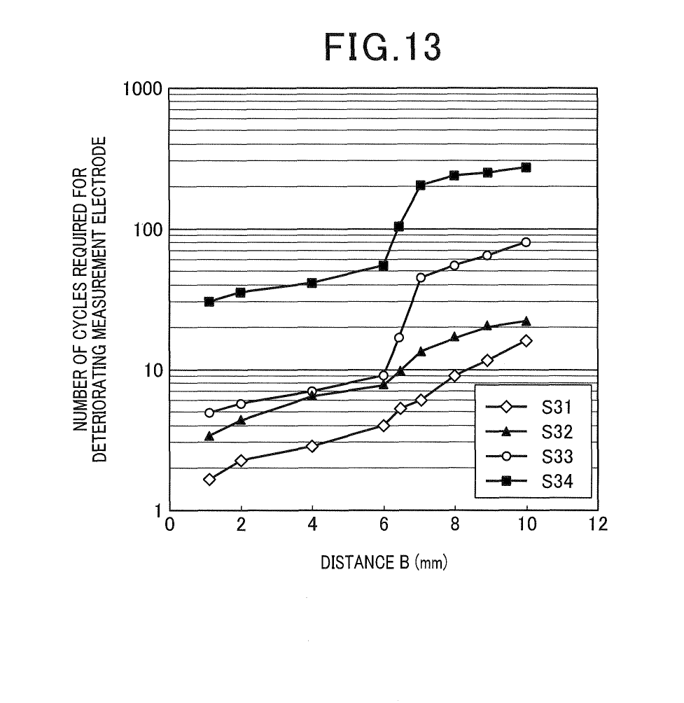

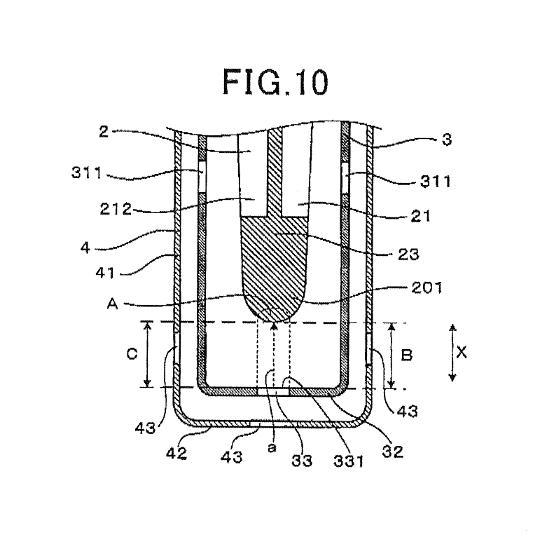

FIG. 13 shows the test results, wherein: the horizontal axis represents the distance B between the distal end of the measurement electrode 23 and the through-hole 33 of the cover 3 in the longitudinal direction X; the vertical axis represents the number of cycles required for deteriorating the measurement electrode 23; the plots “⋄” indicate the results with the gas sensor samples S31; the plots “▴” indicate the results with the gas sensor samples S32; the plots “∘” indicate the results with the gas sensor samples S33; and the plots “▪” indicate the results with the gas sensor samples S34.

As seen from FIG. 13, in the range of the distance B greater than or equal to 7 mm, the number of cycles required for deteriorating the measurement electrode 23 for the gas sensor samples S33 and S34 was considerably larger than that for the gas sensor samples S31 and S32. Moreover, the number of cycles required for deteriorating the measurement electrode 23 for the gas sensor samples S34 was remarkably larger than that for all the other gas sensor samples S31-S33.

Accordingly, from the above test results, it has been made clear that to more reliably suppress deterioration of the measurement electrode 23, the thickness of the protective layer 24 is preferably set to be greater than or equal to 200 μm, and more preferably set to be greater than or equal to 300 μm.

What is claimed is:

1. A gas sensor comprising:
a gas sensor element configured to detect the concentration of a specific component in a measurement gas, the gas sensor element including a solid electrolyte body and a pair of reference and measurement electrodes, the solid electrolyte body having a bottomed tubular shape so as to define a reference gas chamber therein, the reference electrode being provided on an inner surface of the solid electrolyte body so as to be exposed to a reference gas that is introduced into the reference gas chamber, the measurement electrode being provided on an outer surface of the solid electrolyte body so as to be exposed to the measurement gas; and
a cover arranged to cover a distal end portion of the gas sensor element, the cover having at least one through-hole through which the measurement gas is introduced to the measurement electrode, the at least one through-hole being positioned on a distal side of the distal end portion of the gas sensor element in a longitudinal direction of the gas sensor,
wherein
the measurement electrode is positioned, on the outer surface of the solid electrolyte body, outside of an overlapping area that overlaps with the at least one through-hole of the cover in the longitudinal direction of the gas sensor.

2. The gas sensor as set forth in claim 1, wherein a distance between a distal end of the measurement electrode and the at least one through-hole of the cover in the longitudinal direction of the gas sensor is greater than or equal to 7 mm.

3. The gas sensor as set forth in claim 2, wherein the distance between the distal end of the measurement electrode and the at least one through-hole of the cover in the longitudinal direction of the gas sensor is greater than or equal to 8 mm.

4. The gas sensor as set forth in claim 1, wherein the cover is substantially cylindrical cup-shaped to include a side wall and a bottom wall; and
the at least one through-hole of the cover is formed in the bottom wall of the cover.

5. The gas sensor as set forth in claim 4, wherein the at least one through-hole of the cover is a single through-hole that is formed at a central portion of the bottom wall of the cover.

6. The gas sensor as set forth in claim 1, further comprising an outer cover that has a plurality of through-holes formed therein and is arranged to cover an outer periphery of the cover.

7. The gas sensor as set forth in claim 1, wherein the gas sensor element further includes a protective layer that is provided to cover at least part of the measurement electrode, and
the protective layer has a thickness greater than or equal to 200 μm.

8. The gas sensor as set forth in claim 7, wherein the thickness of the protective layer is greater than or equal to 300 μm.
